(19) United States
(12) Patent Application Publication
(10) Pub. No.: US 2006/0048094 A1
(43) Pub. Date: Mar. 2, 2006

(54) Systems and methods for decoupling inputs and outputs in a workflow process

(75) Inventors: Alex Aben-Athar Kipman, Duvall, WA (US); Sumedh Ashok Kanetkar, Seattle, WA (US); Rajeev Goel, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/926,662

(22) Filed: Aug. 26, 2004

(51) Int. Cl. G06F 9/44

(52) U.S. Cl. 717/104

(57) ABSTRACT

Decoupling inputs and outputs in a workflow process may be accomplished by adding a level of indirection. Steps in a workflow can associate their outputs with both a primary identification and a secondary identification. Each step can be configured to accept files or other data associated with particular secondary identifications as input, regardless of the primary identification. Thus, while the output, and thus the primary identification of a step may change, the secondary identification need not change. This reduces the chance of breaking or degrading subsequent downstream steps in a workflow process by modifying an upstream step. The secondary identification may be further associated with metadata, which allows for more sophisticated, input-specific control of the steps in a workflow. A list of the steps in a workflow can be created that incorporates the secondary identification and allows for high-performance integration of build process control into an Integrated Development Environment (IDE).

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2004, Microsoft Corp.

### FIELD OF THE INVENTION

This invention relates to computing, and more particularly to workflow processes in which an initial input is processed by a series of steps to produce a final output, and more particularly communications between the steps in such a process.

### BACKGROUND OF THE INVENTION

FIG. 1a illustrates a generalized workflow process in which an initial input 100 is converted by a workflow process 101 into a final output 102. The initial input 100 is any data. In a typical scenario, initial input 100 is a plurality of files that may be stored in memory. For example, one species of workflow process, a software build process, converts a plurality of source files, as well as other files associated with a software project, into a final output that comprises a plurality of computer executable files. An initial input 100 or final output 102 could also take other forms, such as a modulated data signal.

The workflow process 101 is any process that converts an initial input 100 into final output 102. The workflow process 101 can range from very simple to very complex. A simple workflow process could perform one simple operation on initial input 100 to produce final output. More typically, however, a workflow 101 such as a build process will more drastically modify initial input 100, and may undertake a series of steps to do so, as illustrated in FIG. 1b.

FIG. 1b illustrates a more detailed view of the workflow process in FIG. 1a. An initial input 100 is fed to the workflow process 101 where the input is processed by a plurality of steps 101a-101d. Each step takes some input and produces some output, which may be processed further by a subsequent step. For example, in FIG. 1b, an initial input 100 is passed to workflow process 101, where the initial input 100 is first processed by Step 1 101a. Step 1 101a performs an operation on the initial input 100 and generates some output. The output may be passed directly to a subsequent step or stored in memory. In either case, the output will be given identification(s) such as one or more file name(s). If stored in memory, the output is stored in a particular location or locations. The output may be stored, for example, as unstructured text and/or hard coded file locations on a disk.

This output may then be located by Step 2 101b. Step 2 101b performs a subsequent operation. Step 2 first accesses the output passed to it or stored by Step 1 101a. Step 2 101b then changes the output in some way, and passes the results directly to Step 3 101c or stores the results in memory. Just as with the output from Step 1 101a, the output from Step 2 101b is given identification(s) such as one or more file names. This process can be repeated by the additional steps 101c-101d until the final output 102 is produced. The final output can be stored, just like the intermediary outputs, in particular location(s) in memory and with identification(s) such as one or more file names.

Thus, the steps of a traditional workflow are coupled to one another through their outputs and inputs. One step takes up an input, identified by a name known to the step, in a location where another step left the file as an output. As will be clarified below, this mechanism is awkward, inconsistent and imprecise. As a result, workflow script authors, such as those who design software build processes, spend a great deal of their thought process solving communication problems between steps in a workflow instead of solving problems that substantively improve the final output.

FIG. 1c illustrates a more detailed view of one of the prior art steps 101d from FIG. 1a. The illustration of FIG. 1b is greatly simplified from the reality of most modern workflows, and FIG. 1c is designed to give a more realistic illustration. In general, steps 101a-101d from FIG. 1b will not simply take up the output of a previous step in a linear way. Some steps operate on some aspects of an initial input, while other steps work on other aspects. Commonly, a step 101d in FIG. 1c may process a plurality of outputs from a variety of previous steps, illustrated as 110-114. The outputs from a step 101d may be processed further by a variety of subsequent steps 115-119. Thus, initial input into a workflow process may not advance linearly from step to step, but will typically be divided and passed from step to step in a complex web of workflow processing.

Consider the implications of changing a step in a workflow such as the workflow partially represented in FIG. 1c. Such a workflow may have thousands, even tens of thousands of steps. Any number of downstream steps may be affected by altering a step. For example, a subsequent step may be configured to look for an output stored in memory with a particular identification. If the identification is changed, the step will not find it, and the step may “break” or return an error.

FIG. 1d illustrates how alteration of one step, namely the substitution of 124 for 110 from FIG. 1c, can cause any number of steps in a workflow process to break. Step N 101d cannot accept the output of 124, as illustrated by 125. As a result, any number of further steps 116, 118 in the workflow process may also break, as illustrated by 126 and 127. Even worse, the subsequent steps 116 and 118 could not break, but simply operate improperly and thereby degrade the quality of the final output. In this latter situation, the source of the problem with a final output may be exceedingly difficult to trace.

To avoid the breakage of workflow steps, or degradation of a final output, those who desire improvements to workflows may find themselves burdened with the daunting task of hand tracing all of the potentially thousands of relationships between the various steps to ensure that such negative effects do not occur. In the context of software builds, this may require significant time and effort by a developer who is otherwise involved in different, more pressing activities. The common solution is to simply live with or otherwise work around problems in a build process, rather than attempt to improve the build process.

In addition to the fragility of present workflows to breaks and their susceptibility to degradation of output, the above paragraph touches on yet another drawback in present systems, which is addressed by the solutions provided herein. Namely, the operations of present workflow processes are exceedingly difficult to trace. A first step may modify a stored file, and the file may be subsequently modified by a subsequent step, but because the steps do not leave behind a record of which steps modified a particular file, it can be difficult to determine the weaknesses of the system because the intermediate states of files may be largely unrecorded.

FIG. 1e illustrates a prior art software development process, which includes a workflow process 170. A plurality of files 160a-160h are created with a design tool 150, then converted into executable files 195-197 by a software build process 170. The build process 170 may draw on a second set of files 181-184 to determine various properties of the output computer executable files 195-197.

Indeed, modern software is typically created with a great deal of computer automated assistance. Such assistance is commercially available in a variety of software, generally referred to as integrated development environments (IDEs). For example, MICROSOFT'S VISUAL STUDIO®, BORLAND'S C++ BUILDER®, METROWERK'S CODE WARRIOR®, and IBM'S WEBSPHERE STUDIO® are all products presently available to assist in software creation. Such products provide a range of useful functions, such as coordinating communications between multiple developers working together on large projects, assisting in the actual writing of source code, assisting in specifying how a source code file will be compiled, and software build processes, also referred to as software build engines, that convert source code files and the like into executable files.

The process of developing software using an IDE is depicted in FIG. 1e. First, the software can be designed using a design tool 150. The design tool 150 will typically provide a wide range of design functions for generating any number of files 160a-160h. Files 160a-160h may be files of a variety of types. Some may be files containing source code, while others are files that specify some other properties of the software under development. When the files 160a-160h for a software application are ready, they may be passed to what is known as a build process 170, which is a type of workflow process. Many IDEs have built-in build processes 170. While some IDE products may bifurcate the creation of the files 160a-160h and the build-process 170, others provide software design and build as options through a single user interface.

The build process 170 may comprise any number of steps 171-174. One such step is typically a compiler 171, which may itself comprise a plurality of steps. A compiler 171 is software that provides a function of reading source code and generating binary files, which may be computer-executable, or near-computer-executable files. Another build step is typically a linker 172. A linker supplies the appropriate location references within executable files 195, 196, 197. A plurality of properties desired for executable files 195, 196, 197 may be stored in one or more files 181-184 available to the build process 170. Thus, when the time comes to convert the original files 160a-160h into executable files 195, 196, 197, the build process has access to the build property files 181-184 governing how the build is to be conducted.

A brief example of the above described difficulty posed by present techniques for communicating between steps of a workflow, in the context of a software build process, is instructive. Imagine the scenario where there are two distinct atomic steps in a build process, one which will consume “resx” files and emit “resources” files, and another which will consume, among other things, “resources” files and will emit a binary. An Extensible Markup Language (XML) expression of such a build operation would appear as follows:

| <Target Name=“Build” > | |
|---|---|
| <ResGen | Sources=“a.resx” |
| | GeneratedResources=“bin\debug\a.resources” /> |
| <Csc | Sources=“a.cs” |
| | Resources=“bin\debug\a.resources” /> |
| </Target> | |

The above example inexorably couples the CSC step with the ResGen step. As a result, the sequence of steps is fragile and susceptible to breaking if modifications are made, because now the CSC step must have inherent knowledge of where the ResGen step placed the resource files. For example, changing Resgen to output to bin\foobar\a.resources would break the CSC step, unless the build author remembers to also change the CSC step when ResGen changes.

In a workflow with only two steps, updating all the steps when either step changes is not difficult. However, as described above, a workflow may comprise thousands of steps that are interrelated in a web of complex relationships. If this example is extended to a large build script, with thousands of targets, the ResGen step may have occurred many targets prior to CSC step. The chain of steps between ResGen and CSC may be complex and difficult to trace. Making a modification to any of the steps in such a workflow can bear a high probability of breaking a downstream step, or of incrementally degrading the workflow process.

In light of the above described deficiencies in the art, there is a need in the industry to provide systems and methods to decrease the fragility of workflow processes and likewise their susceptibility to degradation of final output when steps within the workflow are modified. There is further a need to provide better systems and methods for improvement of workflow processes including better tracing of the intermediate outputs from steps within the workflow, and better integration of build process modification tools into IDEs.

### SUMMARY OF THE INVENTION

In consideration of the above-identified shortcomings of the art, the present invention provides systems and methods for decoupling inputs and outputs in a workflow process. Decoupling may be accomplished by adding a level of indirection. Steps in a workflow can associate their outputs with both the typical, primary identification and with a secondary identification. Each step can be configured to accept files or other data associated with particular secondary identifications as input, regardless of the primary identification. Thus, while the output, and thus the primary identification of a step may change, the secondary identification need not change. This reduces the chance of breaking or degrading subsequent downstream steps in a workflow process by modifying an upstream step.

The secondary identification may be conceptually understood as a container, or item, in which the output of a step is packaged. In addition to the secondary identification itself, the item may also include metadata which can be propagated to downstream containers in the workflow. The item with metadata is a richer object than simply raw inputs and outputs, and allows for more sophisticated, input-specific control of the steps in a workflow. Another aspect of the invention is creation of a list of the steps in a workflow using the secondary identifications. The list can provide the steps and the secondary identifications of the inputs and outputs for each step. The workflow itself can be modified, with appropriate software, through modification of the list. This allows for high-performance integration of build process control into an IDE. Thus the invention can provide for better understanding and control over workflows, as well as reducing the likelihood that steps in a workflow will break or degrade the final output. Other advantages and features of the invention are described below.

### BRIEF DESCRIPTION OF THE DRAWINGS

The systems and methods for decoupling inputs and outputs in a workflow process in accordance with the present invention are further described with reference to the accompanying drawings in which:

FIG. 1a illustrates a prior art generalized workflow process in which an initial input 100 is converted by a workflow process 101 into a final output 102.

FIG. 1b illustrates a more detailed view of the prior art workflow process in FIG. 1a. An initial input 100 is fed to the workflow process 101 where the input is processed by a plurality of steps 101a-101d. Each step takes some input and produces some output. The output may be processed further by a subsequent step.

FIG. 1c illustrates a more detailed view of one of the prior art steps 101d from FIG. 1a. Commonly, a step 101d may process a plurality of outputs from a variety of previous steps 110-114. The outputs from a step 101d may be processed further by a variety of subsequent steps 115-119. Thus, initial input into a workflow process may not advance linearly from step to step, but will typically be divided and passed from step to step in a complex web of workflow processing.

FIG. 1d illustrates how alteration of one step, namely the substitution of 124 for 110 from FIG. 1c, can cause any number of steps in a workflow process to break. Step N 101d cannot accept the output of 124, as illustrated by 125. As a result, any number of further steps 116, 118 in the workflow process may also break, as illustrated by 126 and 127.

FIG. 1e illustrates a prior art software development process, which includes a workflow process 170. A plurality of files 160a-160h are created with a design tool 150, then converted into executable files 195-197 by a software build process 170. The build process 170 may draw on a second set of files 181-184 to determine various properties of the output computer executable files 195-197.

FIG. 2a is a block diagram broadly representing the basic features of an exemplary prior art computing device suitable for use in conjunction with various aspects of the invention;

FIG. 2b is a block diagram representing a more detailed exemplary prior art computing device suitable for use in conjunction with various aspects of the invention;

FIG. 2c illustrates an exemplary prior art networked computing environment in which may computerized processes, including those of the invention, may be implemented;

FIG. 3 illustrates various embodiments of the invention used to solve the problem presented in FIG. 1d. Steps, e.g., 324, can associate an output with a generic secondary identification 322, which can be visualized as packaging output in a container 322. Subsequent steps, e.g., 301d, can recognize the secondary identification 322 as bearing the output from a corresponding step 324. Thus, changes to step 324 need not change the container 322, reducing any chance that the workflow process will break or degrade when a step is altered.

FIG. 4 illustrates another view of various embodiments of the invention presented in FIG. 3, in which a step, e.g., 431, receives an output, e.g., 401, 402, 403, that is packaged in a container 400, or associated with a secondary identification, or the like. Step 431 then performs an operation on the output 401, 402, 403, e.g., by transforming it into 410 and 411. Output 410 and 411 can then be packaged in a subsequent container, e.g., 412, and delivered to one or more subsequent steps, e.g., 432.

FIG. 5 illustrates a more detailed view of various embodiments of the invention introduced in FIG. 4, with metadata 500, 501, 502 that may be associated with outputs 401, 402, 403 within the container 400. The metadata 500, 501, 502 can be passed along through the various steps in a workflow process by associating it with outputs in subsequent containers, e.g., 412.

FIG. 6 illustrates a list that identifies the various steps 604 in a workflow process and the generic secondary identifications 605 for the inputs and outputs of the steps. The initial inputs 600-602 to the workflow process may also be set forth in the list.

FIG. 7 illustrates a conceptual diagram for an “item” 700 also referred to herein as a container or a secondary identification. Item 700 may contain an itemlink property 702, an itemstream property 703, and an item attribute collection property 704, which are further described herein.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

### Overview of the Invention

In general, various embodiments of the invention allow creators of workflow processes, or steps in a workflow process, to precisely and generically express the communications between the steps they create. Prior to the invention, such creators were forced to couple steps together through unstructured text and hard coded file locations on disk.

Three aspects of the invention may be used to assimilate the various additional aspects of the invention and multiple potential embodiments. First, secondary identifications, also referred to herein as “items,” “containers,” and “generic identifications,” can be used to decouple steps in a workflow process by normalizing communication between the steps. Second, additional metadata can be associated with the secondary identifications, and propagated to downstream secondary identifications that are created by subsequent steps in the workflow, to control the way that files or other data is treated by various steps along the way. Third, the secondary identifications can be used to define a list, also referred to as a project manifest, which defines the initial inputs and outputs of a workflow process, and which can be used to display and modify features of the workflow process from an IDE GUI.

Turning first to the first aspect of the invention referred to above, namely that items can decouple steps in a workflow by normalizing communication between the steps, the following example is instructive. Compare the fragility of the exemplary XML snippet above in the background section, in which workflow steps that coupled to one another, with the example below, which adds a level of indirection. The example from the background can be rewritten as follows:

| <Target Name=“Build” > | |
|---|---|
| <ResGen | Sources=“a.resx” |
| | GeneratedResources=“bin\debug\a.resources” > |
| <Output ItemName=“Foobar” | |
| TaskParameter=“GeneratedResources” /> | |
| </ResGen> | |
| <CSC | Sources=“a.cs” |
| | Resources=“@(Foobar)” /> |
| </Target> | |

By using secondary identifications, e.g., “Sources,” which is a secondary definition associated with the “a.resx” output, and “GeneratedResources,” which is a secondary identification associated with the “bin\debug\a.resources” output, an author of a workflow process or step in a workflow process, such as a software build process, can completely and robustly decouple the CSC step from the ResGen step. This is because the CSC step will pick up the output associated with “Foobar” regardless of the primary identification for the associated output. Now, if someone were to subsequently change the locations where ResGen emits its resources into, the CSC step is unaffected.

Another way of expressing the above is through a transform:

| <ItemGroup> | |
|---|---|
| <Resx Include=“a.resx” /> | |
| </ItemGroup> | |
| <Target Name=“Build” > | |
| <ResGen | Sources=“@(Resx)” |
| | GeneratedResources=“@(Resx->‘bin\debug\ |
| | %(filename).resources’)” > |
| <Output ItemName=“Foobar” | |
| TaskParameter=“GeneratedResources” /> | |
| </ResGen> | |
| <Csc | Sources=“a.cs” |
| | Resources=“@(Foobar)” /> |
| </Target> | |

Note now that “Sources” as well as “GeneratedResources” are even more generic. GenerateResources in particular is now being defined as a transformation on the inputs. Hence if you were to add more inputs, e.g., “b.resx,” or change the name of the input, the output (GeneratedResources) would automatically adapt to it. If the build process is presented with 100 resx inputs, those inputs would automatically be transformed into 100 .resources files without ever having to touch the build process.

A way to visualize a workflow process that makes use of secondary identifications is as a workflow uses an abstract file system. The secondary identification, which can be seen as an item, as described above, can be thought of as a stream. The location where an item is persisted, if it is persisted at all, is irrelevant to the build operation. As long as a step in a workflow consumes items of a certain secondary identification, and the build author of the step can express the inputs into the step in that form, the step can function properly.

Turning next to the second general aspect of the invention set forth above, the secondary identifications can be associated with additional metadata. This metadata may be directed to anything, including instructions for the manner in which some steps in a workflow are to be performed. By propagating metadata to downstream secondary identifications that are created by subsequent steps in the workflow, the metadata can remain with the initial input to a workflow as it is morphed into various forms by the various steps. Any step that is so configured may check the metadata to determine what operations, if any, to perform. For example, metadata may specify desired language, e.g., English, German, or Japanese. A step that performs translation may check the metadata for the language, and translate an output into the specified language.

Turning finally to the third general aspect of the invention set forth above, the secondary identifications facilitate creation and use of a list that maps the steps, inputs and outputs of a workflow. A first set of secondary identifications may be used to list the initial inputs to a workflow. In the context of a software build process, and from a “host” perspective, these first secondary identifications may define a set of entities a developer interacts with from within the host when a project is opened. Subsequent secondary identifications on the list may be associated with parameters that link the input and output of each step, so that a software developer can trace the build process in detail from start to finish. By modifying the list, a developer can tweak the build process.

Thus, one advantage of the invention is its impact on the software development experience. Secondary identifications allow the a software build process to richly integrate into an IDE, permitting understandable observation and control over the details of the manner in which software is built. When build inputs and outputs are expressed very precisely and unambiguously, a list, also called a project manifest, can be created for access and modification through an IDE that allows unprecedented simplicity and control over software build processes.

### Detailed Description

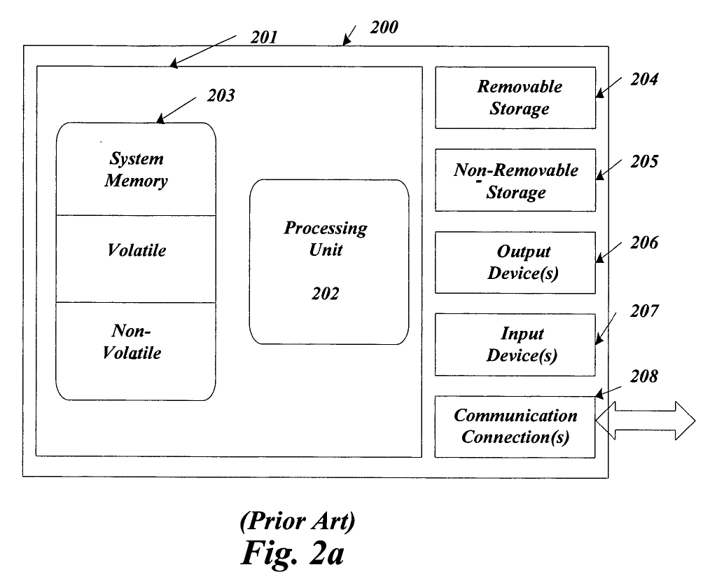

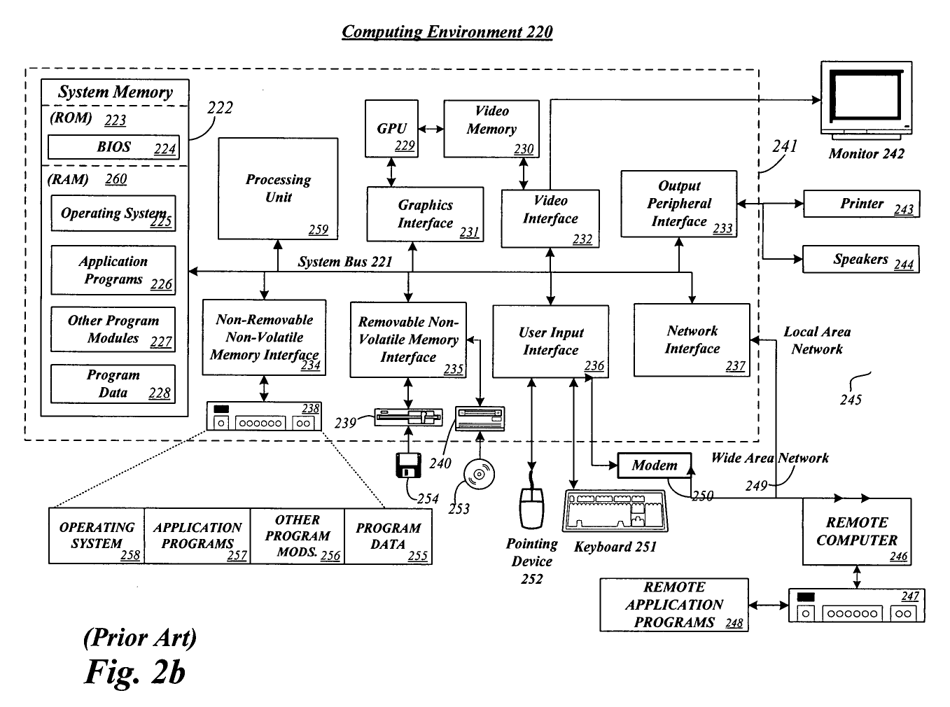

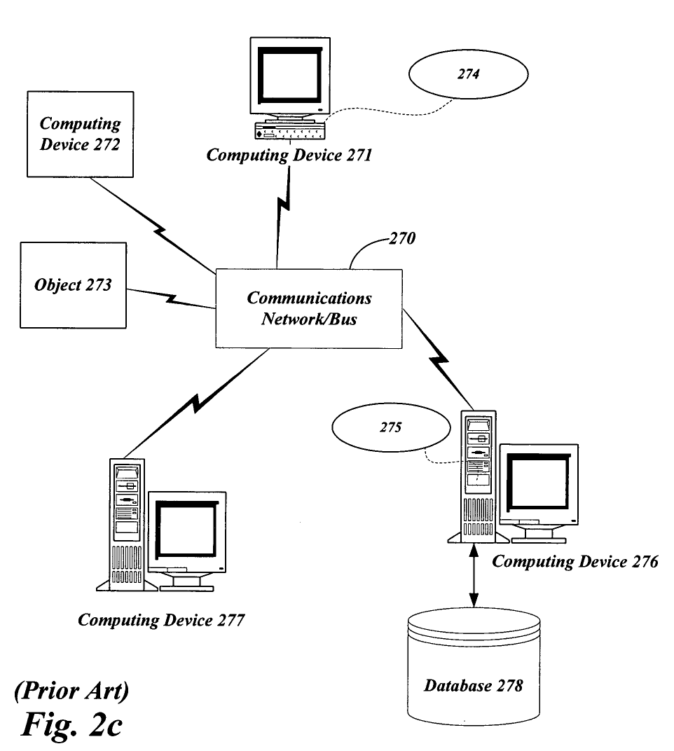

The following detailed description will generally follow the overview of the invention, as set forth above, further explaining and expanding the definitions of the various aspects and embodiments of the invention as necessary. It should be noted first that FIG. 2a, 2b, and 2c provide a prior art computing and networked environment which will be recognized as generally suitable for use in connection with the systems and methods set forth herein. Because the material in FIG. 2a, 2b, and 2c is generally known in the art, the corresponding description is reserved for the end of this specification, in the section entitled “exemplary computing and network environment.”

Two further brief notices should be made prior to a detailed discussion of the various figures and corresponding embodiments of the invention. First, note that the systems and methods disclosed apply generally to workflows. A software build process, or software build engine, as described in the background section, is an exemplary workflow for which the invention is considered to be especially suited. Examples or language provided herein that is unique to the software build embodiment of the invention should be construed as generally applicable to other workflows as well.

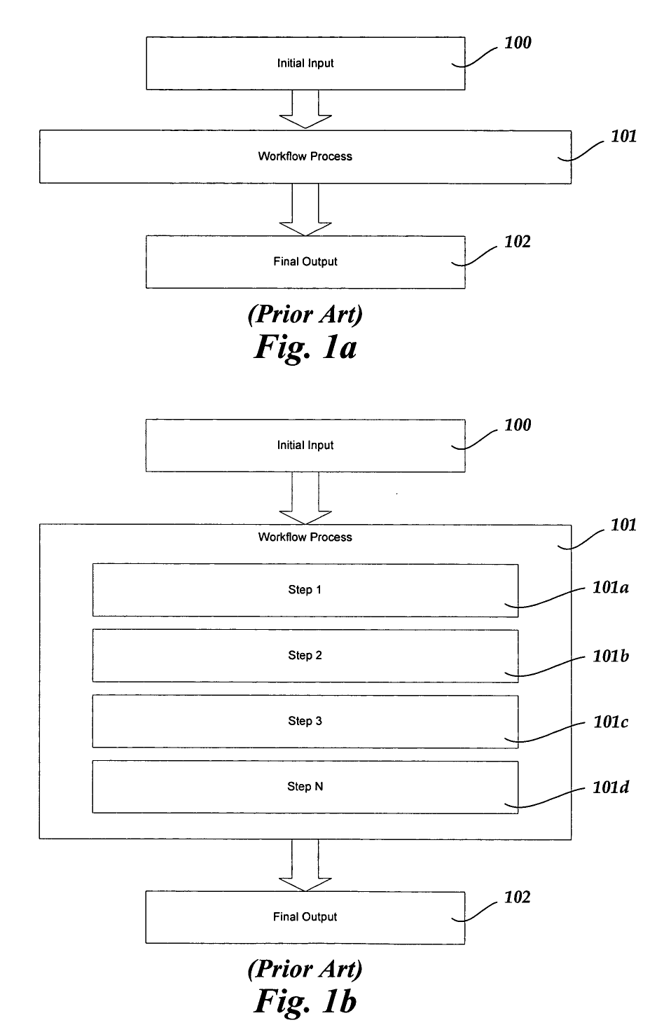

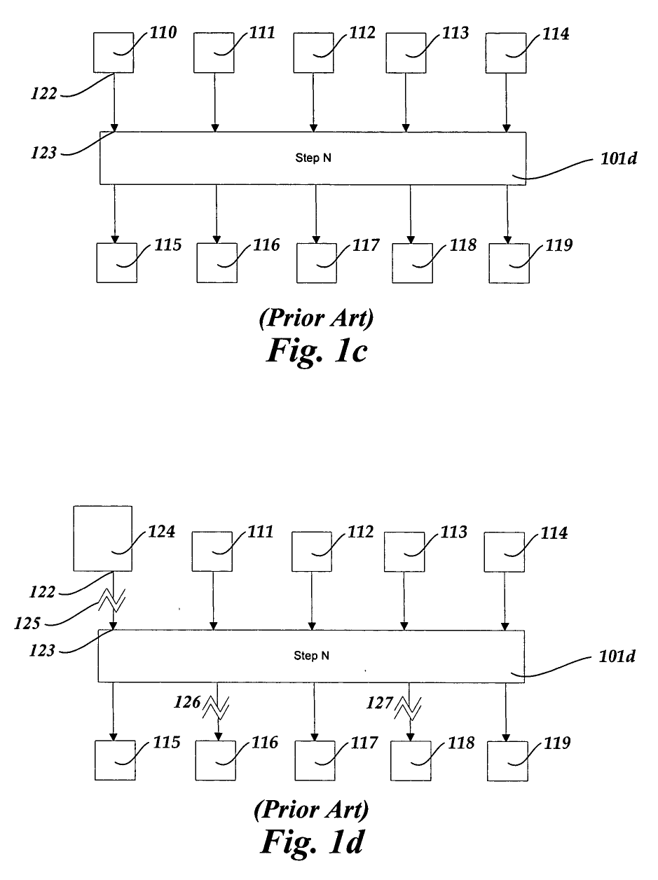

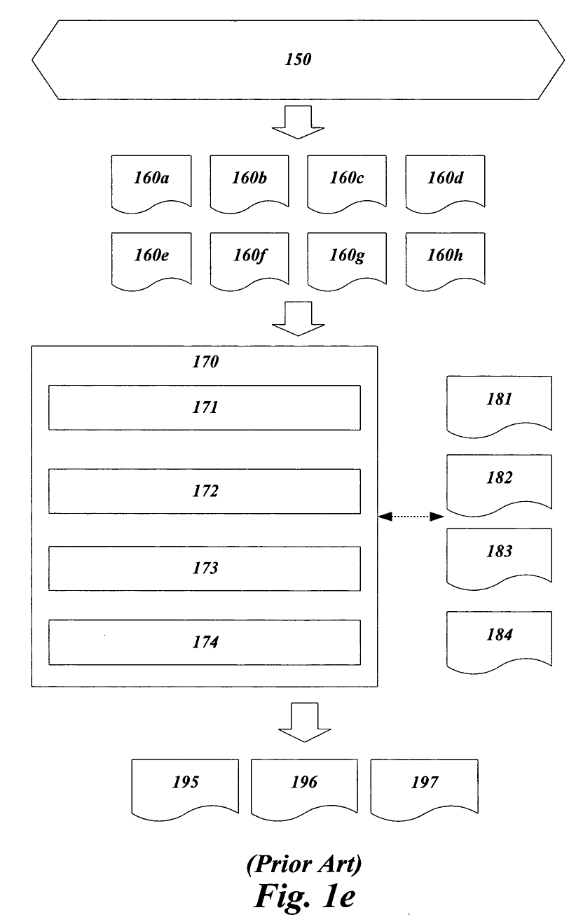

Second, note that in describing the invention, there is some difficulty in distinguishing between the term “input” and the term “output.” This is because, in the context of a workflow, the output of a first step is the input of a next step. This can be understood with reference to FIG. 1c. An output 122 emitted by step 110 is also an input 123 vis-à-vis step 101d. To refer to a file, or other data, first as output, and then to refer to the same file or data as input can become confusing. The proper term depends upon the perspective that is taken. Thus, in some cases, and in the language of the appended claims, both input and output may be referred to as “output” for consistency. Thus, the output of a first step may be subsequently processed by a subsequent step, and that step can be said to perform an operation on output and produces a subsequent output.

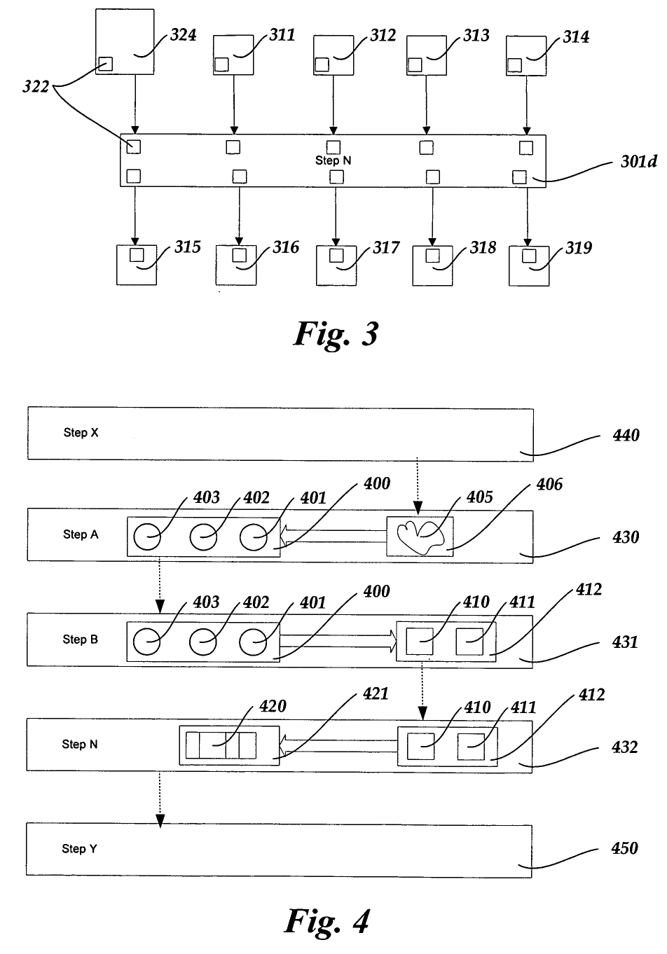

FIG. 3 illustrates various embodiments of the invention used to solve the problem presented in FIG. 1d. Steps, e.g., 324, can associate an output with a generic secondary identification 322. The combination of the secondary identification and the output can be visualized as a container 322 with the output inside. Subsequent steps, e.g., 301d, can recognize the secondary identification container 322 as bearing, or associated with, the output from a corresponding step 324. Moreover, the container itself can direct a subsequent step 301d to the appropriate output. Thus, changes to a step 324 which may change the output of the step, and the primary identification of the output, need not change the secondary identification container 322, thereby reducing any chance that the workflow process will break or degrade when a step 324 is altered.

FIG. 4 illustrates another view of various embodiments of the invention presented in FIG. 3, in which a step, e.g., 431, receives an output, e.g., 401, 402, 403, that is packaged in a container 400, or associated with a secondary identification, or the like. Step 431 then performs an operation on the output 401, 402, 403, e.g., by transforming it into 410 and 411. Output 410 and 411 can then be packaged in a subsequent container, e.g., 412, and delivered to one or more subsequent steps, e.g., 432.

The remaining elements in FIG. 4, namely steps 440, 430, and 450, and element associated with those steps, are illustrated to demonstrate the integration of steps 431 and 432 into a workflow process. While preferred embodiments of the invention utilize secondary identifications in all steps throughout a workflow, the invention is not limited to such embodiments. The invention could also be utilized in as few as two steps in a workflow, one for associating an output with a secondary identification, and another step for reading the secondary identification and retrieving the associated output. Aspects of the invention could also be incorporated into subsections of workflow processes.

It may be beneficial, in various embodiments, to configure certain steps to handle inputs and outputs in a specialized manner. An example of this is the final step in a workflow process, e.g., a step in a software build process that places a completed executable file in an appropriate location for later use by an application. It may be beneficial to omit associating the output of such a step with a secondary identification. Because, in this example, there are no further steps in the workflow that will utilize the secondary identification, it may not be necessary to generate a secondary identification. Likewise, for the first step in a workflow, it may be unnecessary or inappropriate in some embodiments to anticipate a secondary identification with an initial input. Initial inputs may not yet have a secondary identification because they have not yet begun processing by the workflow. Note, however, that in the context of a software build process, initial inputs can be given secondary identifications, and it may even be beneficial to do so, at least in part because it lends itself to a more comprehensive project manifest and thus better integration of a build process with an IDE.

Note that containers 400, 412, and 421 contain multiple output elements. For example, container 400 is associated with output 401, 402, and 403. This illustrates that a single container 400 may be associated with multiple outputs 401. In many steps that take advantage of the secondary identifications of the invention, a single output may be produced, and that output may be associated with a single secondary identification. However, such a simplistic implementation is not required. A step may associate multiple outputs with a single container, as illustrated in FIG. 4. Conversely, a step may associate multiple containers with a single output. In either case, containers can be taken up by another step, the appropriate output can be retrieved, and the subsequent step can place its subsequent output in a subsequent container.

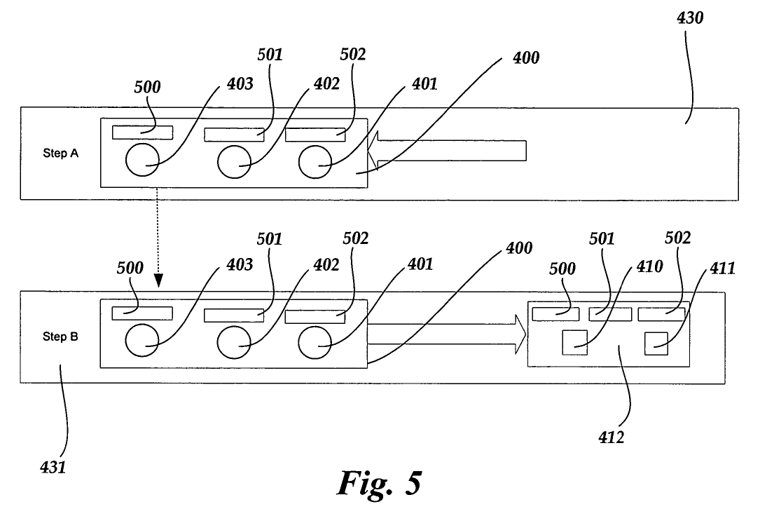

FIG. 5 illustrates a more detailed view of various embodiments of the invention introduced in FIG. 4, with metadata 500, 501, 502 that may be associated with outputs 401, 402, 403 within the container 400. The metadata 500, 501, 502 can be passed along through the various steps in a workflow process by associating it with outputs in subsequent containers, e.g., 412. The following is a brief example of metadata in pseudo-XML for use in a software build process:

```
<ItemGroup>
    <Sources Include=“A.cs” >
        <Localization>ENU</Localization>
    </Sources>
    <Sources Include=“B.cs” >
        <Localization>JPN</Localization>
    </Sources>
</ItemGroup>
```

The secondary identification 400 in FIG. 5 that is created by step A 430 and associated with output 401 is further associated with metadata 502. Moreover, metadata 502 can be associated with particular output 401 within a container 400. Thus, a container 400 that is associated with multiple outputs 401, 402, 403 can have multiple metadata segments 500, 501, and 502, that can be associated with, and tailored to, the multiple outputs. Alternatively, a container may have a single metadata segment that is associated with all outputs of the container. In short, any combination of associations between metadata and outputs may be made within a container.

The combination of outputs and metadata may change, or stay the same as initial inputs are morphed by the steps of a workflow. In preferred embodiments of the invention, however, the combination of initial inputs and metadata is not changed as the initial inputs make their way through a workflow. A brief example of these embodiments, using a simplified workflow, may be instructive. A simple workflow may have ten initial inputs, and ten steps. Each initial input in this example could begin its life in our example associated with a unique secondary identification. Each unique secondary identification may be further associated with a unique set of metadata. Each initial input could go through each step, where an operation is performed that changes the initial input somewhat, and saves resulting subsequent output with a new primary identification, and also associates the subsequent output with a subsequent secondary identification. The original metadata may be associated, by each step, with the subsequent secondary identification. Thus the original metadata follows an initial input as the initial input is modified and saved in perhaps new locations with new names by the various steps of a workflow.

Remaining with the above example, consider one of the hypothetical ten initial inputs. Let us call our selected one initial input Input 7. It may be decided that we do not want step 4 of our hypothetical workflow to do its usual operation on Input 7. Instead, we may want to re-route Input 7 to another, special step, or we may want to simply skip step 4. Using the secondary identifications and associated metadata of the invention, we can state in the metadata for Input 7 that step 4 should be skipped. Step 4 may also be configured to look for the statement in metadata prior to performing its usual operation. When Input 7 arrives at step 4, the metadata statement can be honored, and the operation skipped. Steps may also be configured to perform some modified operation when an appropriate metadata flag is present. For example, a step may translate its input into a language selected from a plurality of languages, depending upon which language is flagged in the metadata associated with the secondary identification that “carries” or is associated with the corresponding input.

Alternatively, the initial inputs may be combined, or separated into more initial inputs by any of the steps in a workflow. This would modify the above example, because the ten initial inputs may be combined into, for example, only 5 data entities, or separated into 20 data entities. In this scenario, the metadata associated with an input may be joined with metadata originally associated with another input, or may be copied and attached to all of the subsequent outputs that an input is split into. In other words, the invention is not limited to a rigid combination of inputs and metadata as inputs and metadata are propagated through a workflow. Neither is the invention limited to retaining metadata. Metadata may no longer be necessary at some point in a workflow, and can be discarded. In preferred embodiments, however, it may be desirable to require that substantially all steps in a workflow propagate metadata to all subsequent secondary identifiers. In a software build process, for example, the steps may be added to or modified by many developers, and may be “pluggable” in that users of a software build process may be permitted to add their own steps to the workflow. In such open systems, requiring the propagation of metadata can be beneficial because it ensures that metadata will serve its purpose rather than be erroneously removed by some step along the way.

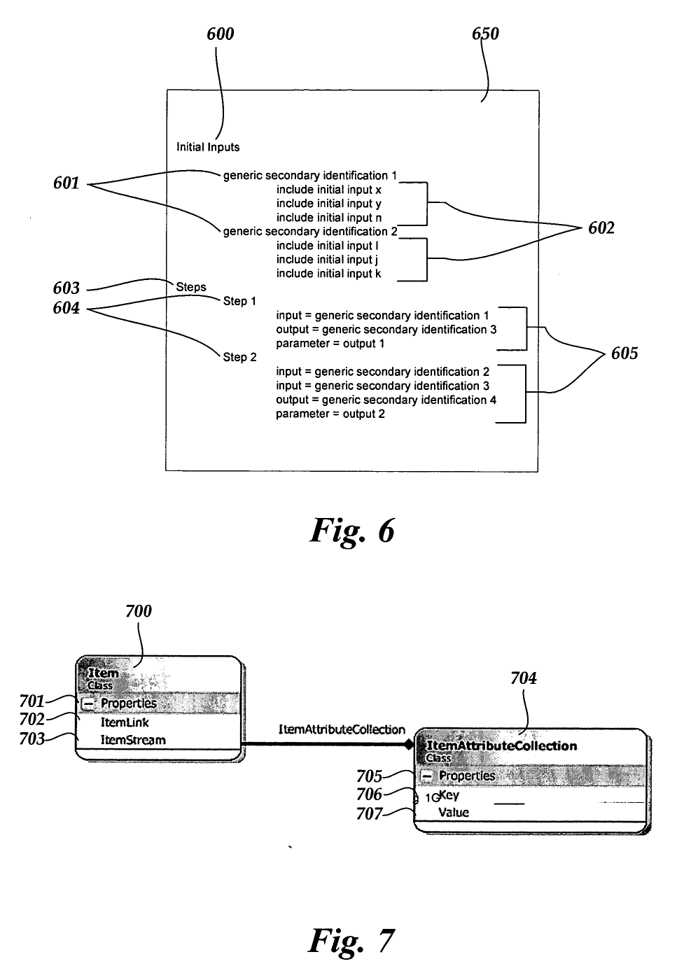

FIG. 6 illustrates a list 650 that identifies the various steps 604 in a workflow process and the generic secondary identifications 605 for the inputs and outputs of the steps. The initial inputs 600-602 to the workflow process may also be set forth in the list. This list can be referred to in the context of a software build process in an IDE as a project manifest, because it can be maintained for the purpose of displaying, understanding, and modifying a software project build process. A pseudo-XML representation of a list according to FIG. 6 may appear as follows:

```
<Project xmlns =“http://schemas.business.com/developer/buildprocess/
year”>
<ContainerGroup>
    <Sources Include=“A.cs”/>
    <Sources Include=“B.cs”/>
    <Resources Include=“A.resx”/>
    <Resources Include=“B.resx”/>
</ContainerGroup>
<Target Name=“A”>
    <Step1 Input=“@(Resources)”>
        <Output ContainerName=“GeneratedResources”
        TaskParameter=“Input”/>
    </Step1>
    <Step2 Input=“@(GeneratedResources)” Input=“@(Sources)”/>
</Target>
```

The list 650 can accomplish a number of advantages. First, the listing of initial inputs, associating the initial inputs 602 with secondary identifications 601, in conjunction with the subsequent use of the secondary identifications in the steps 604 of the workflow, allows for easy tracking of an initial input thought the various steps of a workflow, and identification of the intermediate states of any initial input.

Referring to the example above, the secondary identification referred to as “sources” includes two initial files: A.cs and B.cs, while the “resources” input includes A.resx and B.resx.

Step 1 takes all input associated with the “resources” secondary identification, and produces an output that is associated with a secondary identification called “generated resources.” Step 2 then takes the output of step 1, by referring to the secondary identification of step 1. Step 2 also takes all input associated with the “sources” secondary identification. Using the list, it is clear which steps first take up the initial inputs, what becomes of them, and which step subsequently performs operations on them.

Also, by including a step parameter in a list, the inputs and outputs of a step can be correlated to each other. Thus, from an IDE the complete chain of inputs and outputs for a workflow can be analyzed and modified, by inspecting and modifying the list.

FIG. 7 illustrates a conceptual diagram for an “item” 700, also referred to herein as a container or a secondary identification. Item 700 may contain, or in other words the item may be associated with any number of properties. The properties specifically pointed out herein are the itemlink property 702, the itemstream property 703, and an item attribute collection property 704, which are further described below:

ItemLink—this property can be a pointer to the physical location of the data associated with the item. For example if the item includes a “file” on disk, the ItemLink may consist of the full path to that file.

ItemStream—this property may contain a “data stream” for an item.

ItemAttributeCollection—this property may contain a dictionary of metadata for an item. A dictionary collection can store item meta-data. In some embodiments, access to item metadata may be restricted. A consumer of an item may be permitted to get metadata values based on a key. Additionally a consumer may be able to set a meta-data attribute on an item by providing an attribute key and value.

### Exemplary Computing and Network Environment

With reference to FIG. 2a, an exemplary computing device 200 suitable for use in connection with the systems and methods of the invention is broadly described. In its most basic configuration, device 200 typically includes a processing unit 202 and memory 203. Depending on the exact configuration and type of computing device, memory 203 may be volatile (such as RAM), non-volatile (such as ROM, flash memory, etc.) or some combination of the two. Additionally, device 200 may also have mass storage (removable 204 and/or non-removable 205) such as magnetic or optical disks or tape. Similarly, device 200 may also have input devices 207 such as a keyboard and mouse, and/or output devices 206 such as a display that presents a GUI as a graphical aid accessing the functions of the computing device 200. Other aspects of device 200 may include communication connections 208 to other devices, computers, networks, servers, etc. using either wired or wireless media. All these devices are well known in the art and need not be discussed at length here.

FIG. 2b illustrates a somewhat more detailed example of a suitable computing device from FIG. 2a and peripheral systems. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be implemented in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2b, an exemplary system for implementing the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 2b, provide storage of computer readable instructions, data structures, program modules and other data for the computer 241. In FIG. 2b, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2b. The logical connections depicted in FIG. 2b include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2b illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing the present invention in the context of one or more stand-alone computer systems, the invention is not so limited, but rather may be implemented in connection with any computing environment, such as a network or distributed computing environment. Still further, the present invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

An exemplary networked computing environment is provided in FIG. 2c. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2c provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2c, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2c, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, Hyper Text Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework of provided in FIG. 2a and FIG. 2b, and the further diversification that can occur in computing in a network environment such as that of FIG. 2c, the systems and methods provided herein cannot be construed as limited in any way to a particular computing architecture. Instead, the present invention should not be limited to any single embodiment, but rather should be construed in breadth and scope in accordance with the appended claims.

We claim:

1. A method for passing an output of a first step in a workflow process to a subsequent step in the workflow process, comprising:
producing, by said first step, a first output;
associating the first output with first and second identification;
passing the first output to the subsequent step;
reading the sec0ond identification;
performing, by said subsequent step in the workflow process, an operation on the first output.

2. The method of claim 1, wherein said workflow process comprises a software build process.

3. The method of claim 2, wherein substantially all steps in said software build process associate their outputs with at least two identifications comprising a specific identification and a generic identification.

4. The method of claim 3, wherein substantially all steps in said software build process read the generic identification and perform an operation on an associated output regardless of whether the specific identification takes a first form or a second form.

5. The method of claim 2, further comprising associating, by said first step in the workflow process, metadata with said first output.

6. The method of claim 5, further comprising associating, by said subsequent step in the workflow process, the metadata with a subsequent output, wherein said subsequent output is produced by said performing, by said subsequent step in the workflow process, the operation on the first output.

7. The method of claim 6, wherein substantially all steps in the workflow process associate the metadata with their output when their output is produced by performing an operation on any output associated with the metadata.

8. The method of claim 2, further comprising storing a list comprising an identification of the first step and an identification of the subsequent step, and wherein said second identification is associated with said first step in the list, and wherein said second identification is also associated with said subsequent step in the list.

9. The method of claim 8, wherein the list comprises substantially all steps in the workflow process, and substantially each step on the list is associated with a generic identification of at least one output upon which the step performs an operation, and a generic identification of at least one output produced by the step.

10. The method of claim 8, wherein said list is kept in Extensible Markup Language (XML).

11. The method of claim 8, wherein said subsequent step in the list is further associated with a parameter for correlating said first output with a subsequent output, wherein said subsequent output is produced by said performing, by said subsequent step in the workflow process, the operation on the first output.

12. The method of claim 2, further comprising accessing said list through an Integrated Development Environment (IDE) Graphical User Interface (GUI).

13. A list for exposing the steps of a workflow process, comprising:
at least one first entry associating a generic name for data that is consumed by the workflow with at least one specific name for the data; and
at least one second entry comprising:
a name for a step in the workflow;
the generic name, wherein the generic name identifies an input for the step; and
a second generic name, wherein the second generic name identifies an output of the step.

14. The list of claim 13, wherein the workflow is a software build process.

15. The list of claim 14, wherein the list is in Extensible Markup Language (XML).

16. The list of claim 14, wherein the at least one second entry further comprises an identifier for correlating said generic name with said second generic name.

17. A computer readable medium bearing instructions for passing an output of a first step in a workflow process to a subsequent step in a workflow process, comprising:
instructions for producing, by said first step in the workflow process, a first output with a first identification;
instructions for associating, by said first step in the workflow process, at least the first output with a second identification;
instructions for passing at least the first output and the second identification to the subsequent step in the workflow process;
instructions for reading, by said subsequent step in the workflow process, the second identification;
instructions for performing, by said subsequent step in the workflow process, an operation on at least the first output, wherein the operation is performed regardless of whether the first identification takes a first form or a second form.

18. The computer readable medium of claim 17, wherein said workflow process comprises a software build process.

19. The computer readable medium of claim 18, wherein substantially all steps in said software build process bear instructions for associating their outputs with at least two identifications.

20. The computer readable medium of claim 19, wherein substantially all steps in said software build process bear instructions for reading one of said identifications and performing an operation on an associated output regardless of whether the other of said identifications takes a first form or a second form.

21. The computer readable medium of claim 20, wherein said first form is a first name and said second form is a second name.

22. The computer readable medium of claim 18, further comprising instructions for associating, by said first step in the workflow process, metadata with said first output.

23. The computer readable medium of claim 22, further comprising instructions for providing an access key for said metadata.

24. The computer readable medium of claim 22, further comprising instructions for associating, by said subsequent step in the workflow process, the metadata with a subsequent output, wherein said subsequent output is produced by said performing, by said subsequent step in the workflow process, the operation on the first output.

25. The computer readable medium of claim 24, wherein substantially all steps in the workflow process bear instructions for associating the metadata with their output when their output is produced by performing an operation on any output associated with the metadata.

26. The computer readable medium of claim 20, further comprising instructions for storing a list comprising an identification for the first step and an identification for the subsequent step, wherein said second identification is associated with said first step in the list, and wherein said second identification is associated with said subsequent step in the list.

27. The computer readable medium of claim 26, wherein the list comprises substantially all steps in the workflow process, and substantially each step on the list is associated with a generic identification of at least one output upon which the step performs an operation, and a generic identification of at least one output produced by the step.

28. The computer readable medium of claim 26, wherein said list is kept in Extensible Markup Language (XML).

29. The computer readable medium of claim 26, wherein said subsequent step in the list is further associated with a parameter for correlating said first output with a subsequent output, wherein said subsequent output is produced by said performing, by said subsequent step in the workflow process, the operation on the first output.

30. The computer readable medium of claim 18, further comprising instructions for accessing said list through an Integrated Development Environment (IDE) Graphical User Interface (GUI).
